(19) United States
(12) Patent Application Publication
(10) Pub. No.: US 2011/0133947 A1
(43) Pub. Date: Jun. 9, 2011

(54) GROCERY BAG ALERT SYSTEM AND METHOD

(76) Inventor: Latinka KRAGULJAC, Broadview Heights, OH (US)

(21) Appl. No.: 12/960,676

(22) Filed: Dec. 6, 2010

Related U.S. Application Data
(60) Provisional application No. 61/266,722, filed on Dec. 4, 2009.

(51) Int. Cl. G08B 21/00

(52) U.S. Cl. 340/686.6

(57) ABSTRACT

Systems, devices and other embodiments associated with shopping bags are described. In one embodiment, a device is configured to detect when the device is in a physical vicinity of a grocery store and to generate an alert signal for reminding a user to take grocery bags into the grocery store.

### CROSS REFERENCE TO RELATED APPLICATIONS

This disclosure claims the benefit of U.S. Provisional Patent Application Ser. No. 61/266,722 filed Dec. 4, 2009, titled “Grocery Bag Alert System and Method”, inventor: Latinka Kraguljac, which is incorporated by reference in its entirety herein.

### BACKGROUND

Consumers and corporations have embraced the notion of going “green,” which involves taking actions to protect the environment and conserve resources. It also involves support of environmentally friendly products as opposed to products that pollute or harm the environment.

One such action has been to reduce the use of plastic bags. For example, plastic grocery bags are typically used once and thrown away. As an alternative, store shoppers have started to use non-plastic bags made from cloth or other materials. These bags are typically more stylish, more durable, and thus reusable. The reusable bags can be purchased at stores in order to avoid using the plastic bags.

Too often, shoppers who have previously purchased their own shopping bags forget to take the bags into the store from their car. When the shopper arrives at the checkout aisle with their groceries or other items, they realize that the bags were left in the car. The shopper is then left to use the standard plastic bags or purchase new reusable bags from the store.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. One of ordinary skill in the art will appreciate that in some embodiments one element may be designed as multiple elements or that multiple elements may be designed as one element. In some embodiments, an element shown as an internal component of another element may be implemented as an external component and vice versa. Furthermore, elements may not be drawn to scale.

FIG. 1 illustrates one embodiment of a bag alert device.

FIG. 2 illustrates one embodiment of a bag alert device attached to a shopping bag.

FIG. 3 illustrates an embodiment of a mobile phone configured with a bag alert system.

FIG. 4 illustrates another embodiment of a bag alert device and system.

FIG. 5 illustrates an embodiment of a method associated with detecting whether a device is near a store.

### DETAILED DESCRIPTION

People who have reusable shopping bags many times store the bags in their automobile. Systems, devices, and methods are described herein that alert and/or remind shoppers to use their shopping bags (e.g. reusable grocery bags). In one embodiment, when a shopper is in their car and drives into the parking lot of a grocery store, the present device generates a bag alert, which is an indicator to the shopper to take their reusable bags into the store. Reusing bags saves money and resources.

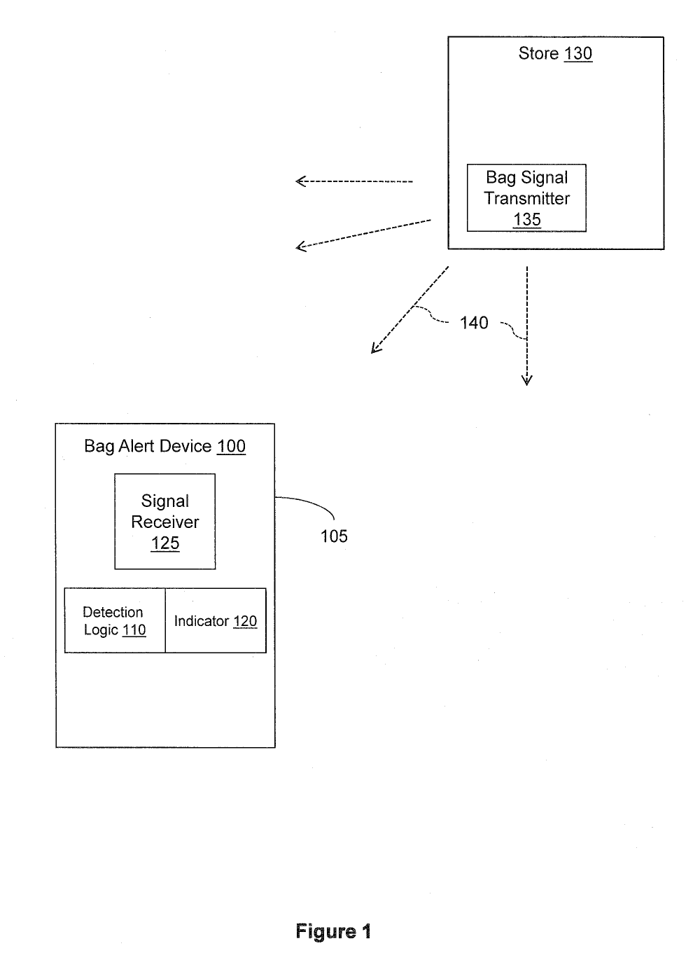

With reference to FIG. 1, one embodiment of a bag alert device 100 is illustrated. The bag alert device 100 includes a housing 105 that contains detection logic 110 configured to detect when the bag alert device 100 is in a physical vicinity of a store 130 (e.g. grocery store). In response to detecting that the device 100 is in a physical vicinity of the grocery store 130, the detection logic 110 generates an alert signal for reminding a user to take shopping bags into the grocery store.

Shopping bags are most likely stored in an automobile (along with the bag alert device 100) so that when the shopper drives into the parking lot of the store 130, the bag alert signal is generated. The bag alert signal is output to an indicator 120 that may be a speaker, a light (e.g. light emitting diode), a display screen, or combinations of these. In one embodiment, the bag alert device 100 includes a signal receiver 125 for receiving wireless signals. The signals are analyzed by the detection logic 110 to determine whether the signals are particular signals 140 transmitted from the store 130. This is described in more detail below. In one embodiment, the device 100 also includes a power source (e.g. a battery) contained in the housing 105 that powers the components therein.

In one embodiment, the bag alert device 100 is be implemented as a small device that attaches to a reusable shopping bag (e.g. clipped on or embedded into material). Typically, shopping bags that are reusable are made from more durable materials (e.g. cloth, nylon, polyester, other synthetic materials) than the ordinary blue or white disposable grocery bags, which are made from very thin plastic. The reusable shopping bags are usually stored in a shopper's automobile. In another embodiment, the bag alert device 100 is placed in the automobile or in a shopper's purse.

When the shopper's automobile approaches a grocery store, the bag alert device 100 detects that it is in the physical vicinity of the store and generates an alert signal. The alert signal reminds the shopper to bring their shopping bags into the store. In this manner, shoppers can more frequently use their reusable shopping bags rather than using the disposable plastic bags. This can reduce expenses for the grocery store by reducing the amount of plastic bags provided to shoppers and can also reduce the waste of the disposable bags.

In one embodiment, to detect that the bag alert device 100 is in the physical vicinity of a grocery store (e.g. store 130), the signal receiver 125 is configured to operate with radio frequency signals. In this operation, the grocery store 130 includes a bag signal transmitter 135 that transmits predetermined radio signals 140 that are associated with the bag alert. In order to receive radio signals, the signal receiver 125 includes an antenna and a radio tuner to tune in to a predetermined frequency or frequency range. The predetermined radio signals 140 transmitted from the store 130 are configured with a particular frequency or range that the signal receiver 125 is tuned for.

When signals are detected by the signal receiver 125 that are in its programmed frequency or range, it is an indication that a store 130 is physically near. In another embodiment, the signals 140 are transmitted with a particular signal pattern. The bag alert device 100 is pre-programmed or configured to recognize the particular signal pattern from the signals 140 emitted from the bag signal transmitter 135. If the pattern is detected, then the store 130 is found and since the system operates with only short range signals, then the bag alert device 100 is in the physical vicinity of the store 130.

In one embodiment, the bag alert device 100 and the detection logic 120 is configured with radio-frequency identification (RFID) components (e.g. an electronic tag) that use communication via electromagnetic waves that receive and/or exchange data between a terminal (e.g. the bag signal transmitter 135). The electronic tag is configured as part of the detection logic 110 or attached to the bag alert device 100.

In one embodiment, the RFID tag contains at least two components. One component is an integrated circuit for storing and processing information, modulating and demodulating a radio-frequency (RF) signal, and other desired functions. The other component is an antenna (e.g. signal receiver 125) for receiving the bag signals 140 from the store 130. In another embodiment, the RFID tag can receive and transmit signals. In this manner, the bag alert device 100 and the bag signal transmitter 135 are configured as a system that communicates to each other.

Different types of RFID tags may be used. For example, passive RFID tags do not use a power source and need an external electromagnetic field to initiate a signal transmission. Active RFID tags contain a battery and can transmit signals once an external source (an interrogator) has been successfully identified, which is the bag signal transmitter 135 from the store 130. A battery assisted passive (BAP) RFID tag requires an external source to wake up the device but has a higher forward link capability providing greater range of communication.

In one embodiment, being in the physical vicinity includes being in the store 130 or in the parking lot that is outside the store 130. Thus the transmitter 135 and receiver 125 are configured to operate with each other within a short range (e.g. less than 100-200 meters from the bag signal transmitter 135. Of course depending on the size of the store 130 and its parking lot, the bag signal transmitter 135 can be configured to transmit various distances by varying signal strength.

In another embodiment, the bag signal transmitter 135 and the bag alert device 100 are configured to operate with Bluetooth™ wireless protocol, IEEE 802.11 compatible protocol, or other short range wireless protocol.

In another embodiment, the detection logic 110 is programmable to detect a predetermined wireless signal that is transmitted from the grocery store. For example, programmable logic (e.g. field programmable gate arrays, erasable memories, loading a new signal pattern, and so on) can be used to detect a selected signal pattern. Thus customizable systems can be configured for a particular store to have unique bag alert signals 140 and associated bag alert devices 100 that only function with their store. For example, the bag alert device 100 only generates an alert signal when near its associated store (e.g. designated signal pattern from XYZ store is recognized). This may help to increase customer loyalty to a store.

In another embodiment, the bag alert device 100 is configured to operate with the Global Positioning System (GPS). For example, the detection logic 120 is configured determine the current location of the bag alert device 100 using GPS. The detection logic 120 can then determine when the bag alert device 100 is in the physical vicinity of the grocery store by comparing its current location with respect to a known position of a grocery store. For example, the addresses (or GPS positions) of one or more associated stores can be programmed into the bag alert device. The detection logic 110 then determines the distance between the current location of the bag alert device 100 to one of the associated stores and triggers the alert signal if the distance is within a designated range (e.g. 100-200 meters).

In one embodiment, the alert signal may be an audible signal (e.g. beeps) that alerts the user to take their grocery bags into the grocery store. In another embodiment, the alert signal is a sound recording that plays a message through the indicator 120 (e.g. speaker). For example, the bag alert device 100 includes a memory that stores a digital message and the detection logic 110 is configured to cause the digital message to be played through the speaker when the device is in the physical vicinity of the grocery store. Example messages can include voice messages that state, “don't forget your bags”; “take your bags”, equivalent messages, other messages that give a reminder about the bags, and so on.

In another embodiment, the bag alert device 100 may be programmed to generate the alert signal that is broadcast to the car radio. A message is then heard through the car radio speakers that remind the driver and passengers to take their grocery bags. In another embodiment, the alert signal is transmitted to the user's mobile phone as a text message, via Bluetooth communication or other short range communication protocol. The alert signal then is displayed and/or heard via the mobile phone.

In another embodiment, the indicator 120 may include a display screen and the alert signal includes a text message that is displayed. This configuration can be implemented in an embodiment where the bag alert device 100 is configured within another electronic device (e.g. a mobile phone as described in FIG. 3).

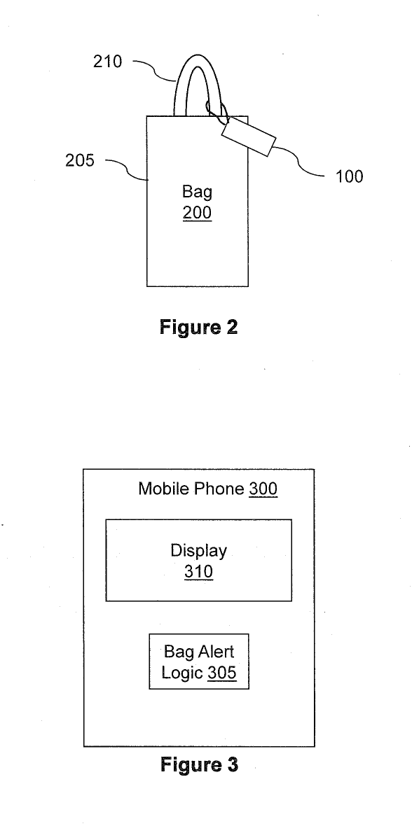

With reference to FIG. 2, one embodiment of a shopping bag 200 is illustrated. For example, the shopping bag is a grocery bag that includes a body portion 205 that defines a compartment for holding items. A handle 210 is attached to the compartment/body portion 205. The bag alert device 100 as described herein is attached to the grocery bag 200. The device 100 can be configured and attached as a luggage-tag type device, or configured as a chip in a small device and embedded in or on the material of the bag 200. As discussed, the bag alert device 100 detects when the grocery bag 200 is physically near a grocery store and generates a signal that reminds a user to take the grocery bag 200 into the grocery store.

With reference to FIG. 3, one embodiment of mobile phone 300 is illustrated that includes bag alert logic 305. The bag alert logic 305 is configured with the store detection functions as described in FIG. 1 except it uses the wireless components of the mobile phone 300 to receive signals. The mobile phone 300 includes at least a processor, memory, display, keypad, cellular communication components, and operating system. In one embodiment, the mobile phone 300 also includes a short range wireless transceiver. The bag alert logic 305 includes the detection logic 110 (shown in FIG. 1), which is configured to detect a signal from the grocery store when the mobile phone 300 is in a vicinity of the grocery store. In response to the detected signal, the mobile phone 300 generates the bag alert signal.

In one embodiment, the mobile telephone 300 includes a non-transitory computer-readable medium configured with the bag alert logic 305. In one embodiment, logic 305 can be loaded as an executable application. The alert signal can include an audible signal, a text message, a pre-recorded message, an alarm, a phone call, and so on. In another embodiment, the bag signal transmitter 135 is configured to transmit text messages to customers that are in range.

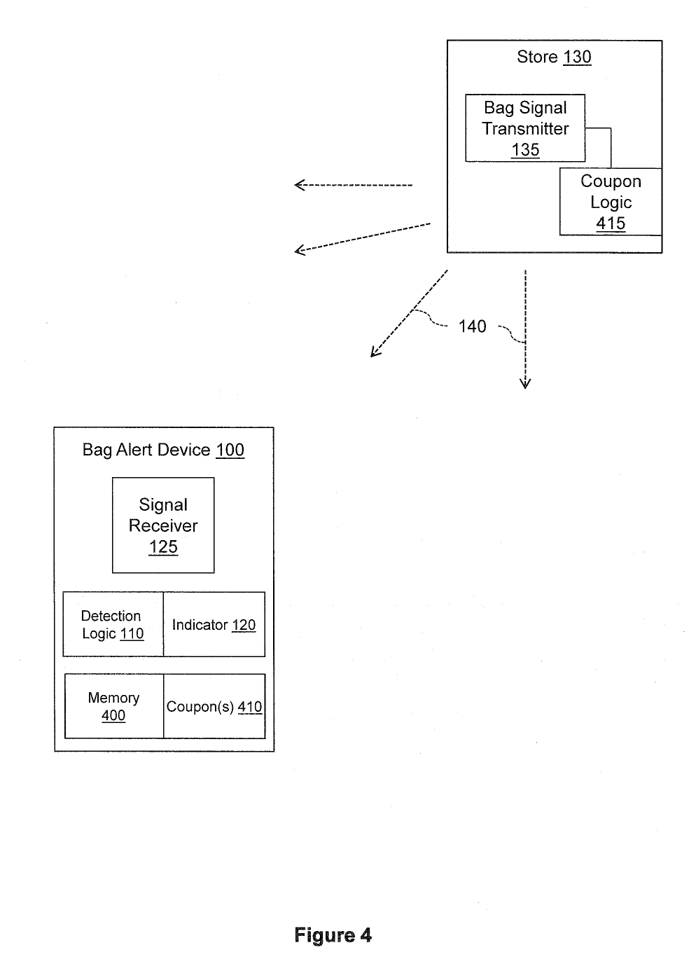

With reference to FIG. 4, another embodiment of the bag alert system from FIG. 1 is illustrated. The bag alert device 100 includes similar components and further includes memory 400 for storing electronic coupons 410. The bag signal transmitter 135 includes coupon logic 415 and an associated memory for storing electronic coupons. The coupons may be images of coupons, coupon codes, text coupons, and so on.

For example, the coupon logic 415 is configured to select one or more electronic coupons from the memory (or generate a coupon) and cause the bag signal transmitter 135 to transmit the selected one or more electronic coupons using the wireless communications as the signals 140 along with the bag alert signal (e.g. in parallel or serially).

The detection logic 110 is configured to identify whether a wireless transmission received from the grocery store 130 includes an electronic coupon. This may include decoding and analyzing the signals for recognized data patterns that identify the signal as a coupon. In response to detecting a coupon, the detection logic 110 stores the electronic coupon from the wireless transmission into the memory 400. In this manner, the shopper can then redeem the electronic coupon by presenting the bag alert device 100 within the store 130 where it can be scanned to read the coupon(s) 410 stored therein. If the bag alert device 100 includes a display, then the coupon can be displayed and read therefrom. Providing coupons to customers may assist in attracting customers to the store 130.

In one embodiment, the wireless communications 140 are readable only within a physical vicinity of the bag signal transmitter 135 as described previously. Thus shoppers who possess the bag alert device 100 and arrive at or near the store are rewarded with the electronic coupons, which are transmitted to their bag alert device 100.

In another embodiment, the bag alert device 100 is configured to delete the electronic coupon(s) 410 from the memory 400 when the bag alert device 100 moves outside the physical vicinity/range of the bag signal transmitter 135. In this manner, the electronic coupons 410 exist when the shopper and the bag alert device 100 are within the premises of the store 130 and disappear when they leave. For example, a shopper drives into the parking lot of the store 130. The bag alert device 100 detects the signals 140 from the bag signal transmitter 135 and determines that they contain coupons. The coupons are stored in memory 400. The shopper can use the coupons when they enter the store 130 with the bag alert device 100. Once they leave the range of the transmitter 135, the coupons 410 are deleted from memory 400. In this way, the store 130 can transmit coupon specials to shoppers via the bag alert device 100 each time the shoppers arrive at the store.

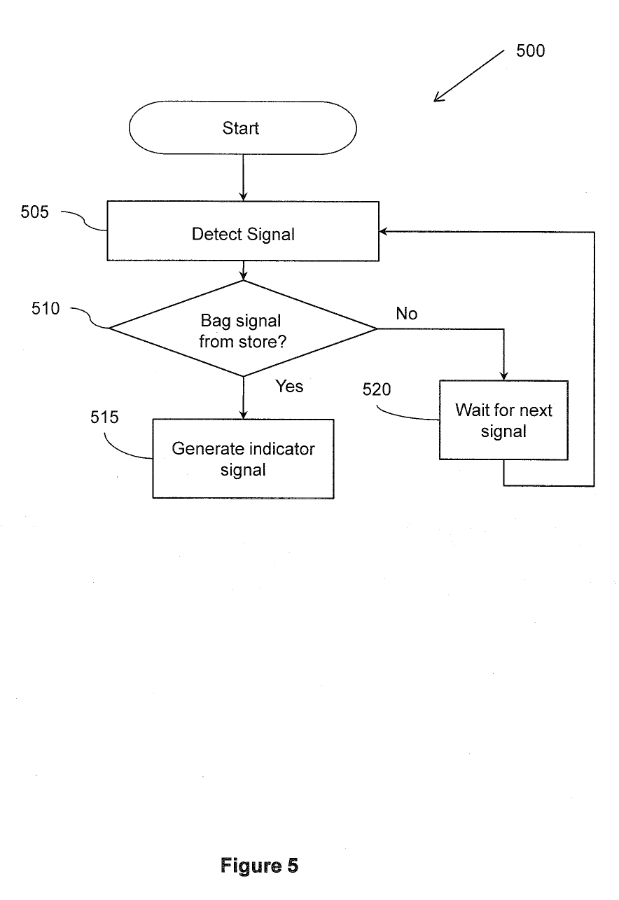

With reference to FIG. 5, one embodiment of a method 500 is shown that is associated with a bag alert device similar to the bag alert device 100 of FIG. 1. The method 500 begins at 505 when a wireless signal is received and detected. At 510, the method determines if the signal is a recognized identification signal from a corresponding store. In one embodiment, 510 can include converting radio frequency signals to digital form and reading data from the signal. Signal patterns can be compared to one or more programmed/stored signal patterns. If there is a match, the method determines that the device 100 is physically near a store. At 515, an indicator signal is generated to alert the shopper to bring their shopping bags into the store.

If at 510 the detected signal is not from a recognized store, then at 520, the method waits for the next signal and repeats.

In another embodiment, the bag alert device is configured in a card. For example, many stores provide key chain cards to customers. The key chain card is used to provide discounts, provide offers to customers, track customer purchases, and so on. The card can include circuitry of the bag alert device that detects when it approaches the grocery store and generates a reminder signal to the card holder to take their bags into the store. In one embodiment, the card can include a light and/or audible signal associated with a message to take their bags (e.g. card includes printed text “take bags” and a light that activates when in the vicinity of the store).

In one embodiment, the bag alert device is a device that includes signal detection circuitry and a speaker/light to generate the audible signal or pre-recorded voice message.

In another embodiment, the bag alert device 100 is configured in a hand held electronic device, which may or may not include a cellular phone. Examples include a personal digital assistant, a music player, a computer, and so on.

In another embodiment, the signal transmitted by the grocery store can include a text/voice message that when received by a nearby wireless device causes the wireless device to display or play the text/voice message.

The bag alert device and store transmitter can be configured to operate with other types of shopping stores that use shopping bags.

In another embodiment, the described components, methods and/or their equivalents may be implemented with computer executable instructions. Thus, in one embodiment, a non-transitory computer-readable medium is configured with stored computer executable instructions that when executed by a machine (e.g., processor, computer, and so on) cause the machine (and/or associated components) to perform the functions described or their equivalents. The described components may be implemented with integrated circuitry in other embodiments.

While for purposes of simplicity of explanation, the illustrated methodologies in the figures are shown and described as a series of blocks, it is to be appreciated that the methodologies are not limited by the order of the blocks, as some blocks can occur in different orders and/or concurrently with other blocks from that shown and described. Moreover, less than all the illustrated blocks may be used to implement an example methodology. Blocks may be combined or separated into multiple components. Furthermore, additional and/or alternative methodologies can employ additional blocks that are not illustrated.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

ASIC: application specific integrated circuit.

ROM: read only memory.

PROM: programmable ROM.

EPROM: erasable PROM.

EEPROM: electrically erasable PROM.

“Computer-readable medium”, as used herein, refers to a non-transitory medium that stores instructions and/or data. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an ASIC, a CD, other optical medium, a RAM, a ROM, a memory chip or card, a memory stick, and other media from which a computer, a processor or other electronic device can read.

“Logic”, as used herein, includes but is not limited to hardware, firmware, a non-transitory computer readable medium that stores instructions, instructions in execution on a machine, and/or combinations of each to perform a function(s) or an action(s), and/or to cause a function or action from another logic, method, and/or system. Logic may include a microprocessor, a discrete logic (e.g., ASIC), an analog circuit, a digital circuit, a programmed logic device, a memory device containing instructions, and so on. Logic may include one or more gates, combinations of gates, or other circuit components. Where multiple logics are described, it may be possible to incorporate the multiple logics into one physical logic. Similarly, where a single logic is described, it may be possible to distribute that single logic between multiple physical logics.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Therefore, the disclosure is not limited to the specific details, the representative apparatus, and illustrative examples shown and described. Thus, this application is intended to embrace alterations, modifications, and variations that fall within the scope of the appended claims.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use. See, Bryan A. Garner, A Dictionary of Modern Legal Usage 624 (2d. Ed. 1995).

What is claimed is:

1. A device comprising:
a housing that contains detection logic configured to detect when the device is in a physical vicinity of a grocery store; and
in response to detecting that the device is in a physical vicinity of the grocery store, the detection logic is configured to generate an alert signal for reminding a user to take grocery bags into the grocery store.

2. The device of claim 1, where the device comprises:
a memory stored with a digital message;
a speaker; and
where the detection logic is configured to cause the digital message to be played through the speaker when the device is in the physical vicinity of the grocery store.

3. The device of claim 1, where the device comprises a radio frequency identification tag configured to detect a signal from the grocery store when the device is in the physical vicinity of the grocery store.

4. The device of claim 1 where the device is a mobile phone including:
a short range wireless transceiver; and
where the detection logic is configured to detect a signal from the grocery store when the mobile phone is in a vicinity of the grocery store and, in response to the detected signal, generates the alert signal.

5. The device of claim 1, where the detection logic is programmable to detect a predetermined wireless signal that is transmitted from the grocery store.

6. The device of claim 1, where the device is attached to a shopping bag.

7. The device of claim 1, where the device is a mobile telephone including a non-transitory computer-readable medium configured with the detection logic.

8. The device of claim 1, where the detection logic is configured to detect when the device is in the physical vicinity of the grocery store by determining a position of the device with respect to a position of the grocery store using global positioning.

9. The device of claim 1, where the device comprises a memory; and
where the detection logic is configured to identify whether a wireless transmission received from the grocery store includes an electronic coupon, and in response thereto, to store the electronic coupon from the wireless transmission into the memory.

10. A system comprising:
a bag signal transmitter configured for placement associated with a store, the bag signal transmitter being configured to transmit a predetermined signal via wireless communications at least in a vicinity of the store; and
a bag alert device configured to detect the predetermined signal when the bag alert device is within the vicinity of the store, and in response to the detection, to generate an alert signal for alerting a user to take bags into the store.

11. The system of claim 10, where the bag signal transmitter is further configured to generate and transmit signals representing an electronic coupon;
where the bag alert device includes a memory; and
where the bag alert device is configured to identify the signals associated with the electronic coupon and to store the electronic coupon in the memory in the bag alert device.

12. The system of claim 11, where the bag alert device is configured to delete the electronic coupon from the memory when the bag alert device is outside a physical vicinity of the bag signal transmitter.

13. The system of claim 10, further comprising:
a memory configured to store a plurality of electronic coupons; and
coupon logic configured to select one or more electronic coupons from the memory and cause the bag signal transmitter to transmit the selected one or more electronic coupons using the wireless communications, where the wireless communications are readable only within a physical vicinity of the bag signal transmitter.

14. A grocery bag comprising:
a compartment for holding items;
a handle attached to the compartment; and
a bag alert device attached to the grocery bag and configured to:
detect when the grocery bag is physically near a grocery store; and
generate a signal that reminds a user to take the grocery bag into the grocery store.

15. The grocery bag of claim 14, where the bag alert device comprises:
a speaker or a light; and
where the detection logic is configured to cause a pre-recorded message to be played through the speaker or to cause the light to illuminate when the device is in the physical vicinity of the grocery store.

16. The device of claim 14, where the device comprises a radio frequency identification tag configured to detect a signal from the grocery store when the device is in a physical vicinity of the grocery store.
